(19) United States
(12) Patent Application Publication
(10) Pub. No.: US 2026/0021705 A1
(43) Pub. Date: Jan. 22, 2026

(54) CONTROL DEVICE FOR VEHICLE

(71) Applicant: HONDA MOTOR CO., LTD., Tokyo (JP)

(72) Inventors: Yuki MASUDA, Tokyo (JP); Shoichiro TANAKA, Tokyo (JP)

(73) Assignee: HONDA MOTOR CO., LTD., Tokyo (JP)

(21) Appl. No.: 19/269,671

(22) Filed: Jul. 15, 2025

(30) Foreign Application Priority Data
Jul. 22, 2024 (JP) 2024-116741

(51) Int. Cl. B60L 3/00; B60L 15/20

(52) U.S. Cl. CPC B60L 3/0061; B60L 15/20; B60L 2240/423; B60L 2240/425; B60L 2250/10

(57) ABSTRACT

A control device for a vehicle including a motor as a drive source, the control device includes a stall determination unit configured to determine a stall state of the motor in which the motor is not rotating, in a state in which a torque of the motor is generated based on a drive instruction; and a torque control unit configured to perform a torque control for controlling the torque to change a rotation angle of the motor in response to the motor being determined to be in the stall state. The torque control unit performs the torque control at a predetermined frequency based on a temperature of the motor.

This application is based upon and claims the benefit of priority from prior Japanese patent application No. 2024-116741, filed on Jul. 22, 2024, the entire contents of which are incorporated herein by reference.

### TECHNICAL FIELD

The present disclosure relates to a control device for a vehicle.

### BACKGROUND ART

In recent years, efforts to realize a low-carbon society or a decarbonized society become active, and research and development about an electrification technique are conducted to reduce CO₂ emission and improve energy efficiency in vehicles.

For example, in a vehicle equipped with a motor as a drive source, there is known means for preventing, in a case where the vehicle is stopped on an uphill road or a motor torque of such a degree that the vehicle does not slip down is output, a stall state in which rotation of the motor is substantially stopped or a motor locking state in which an output of the motor rapidly decreases due to a current continuously flowing in a specific phase even though the motor torque is applied.

JP4725419B describes a control for notifying, when it is determined that there is a possibility of motor locking, a user of the possibility of the motor locking by increasing or decreasing a motor torque to apply vibration to a vehicle.

### SUMMARY OF INVENTION

Since the application of vibration to the vehicle by executing the control for increasing or decreasing the motor torque results in a behavior of the vehicle that is not intended by the user, a frequency of the control is preferably low. In the related art, the control for increasing or decreasing the motor torque is executed using a temperature of the motor as one parameter, but a specific temperature state of the motor is not considered, and for example, even if the temperature of the motor is relatively low, the control for increasing or decreasing the motor torque is executed to apply vibration to the vehicle, and thus there is a concern that a frequency of increasing or decreasing the motor torque increases.

Aspects of the present disclosure relate to providing a control device for a vehicle enabling escaping from a stall state while limiting a frequency of increasing or decreasing a motor torque in the stall state.

According to an aspect of the present disclosure, there is provided a control device for a vehicle including a motor as a drive source, the control device including:
a stall determination unit configured to determine a stall state of the motor in which the motor is not rotating, in a state in which a torque of the motor is generated based on a drive instruction; and
a torque control unit configured to perform a torque control for controlling the torque to change a rotation angle of the motor in response to the motor being determined to be in the stall state, in which
the torque control unit performs the torque control at a predetermined frequency based on a temperature of the motor.

According to the present disclosure, escaping from the stall state is enabled while limiting the frequency of increasing or decreasing the motor torque in the stall state.

### BRIEF DESCRIPTION OF DRAWINGS

Exemplary embodiment(s) of the present invention will be described in detail based on the following figures, wherein:

FIG. 1 is a schematic diagram showing an example of a configuration of a vehicle Ve;

FIG. 2 is a block diagram showing an example of a control device 10;

FIG. 3 is a time chart showing an example of a change in each parameter when a control example in an embodiment is executed;

FIG. 4 is a diagram showing an example in which a motor rotation speed is overshot in a torque return control;

FIG. 5 is a diagram illustrating each region in which a depressing change from an accelerator pedal to a brake pedal is assumed;

FIG. 6 is a time chart showing an example of a change in each parameter when the brake pedal is operated during execution of a torque decrease control;

FIG. 7 is a time chart showing an example of a change in each parameter when the brake pedal is operated during execution of the torque return control; and

FIG. 8 is a time chart showing an example of a change in each parameter when the brake pedal is operated during execution of a torque balance control.

### DESCRIPTION OF EMBODIMENTS

Hereinafter, an embodiment will be described with reference to the accompanying drawings. The following embodiment does not limit the present disclosure, and not all of elements described in the following embodiment are necessary to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

A control device 10 in the embodiment is mounted on a vehicle Ve, and the control device 10 mainly controls a torque of a motor 1 which is a drive source.

### Vehicle

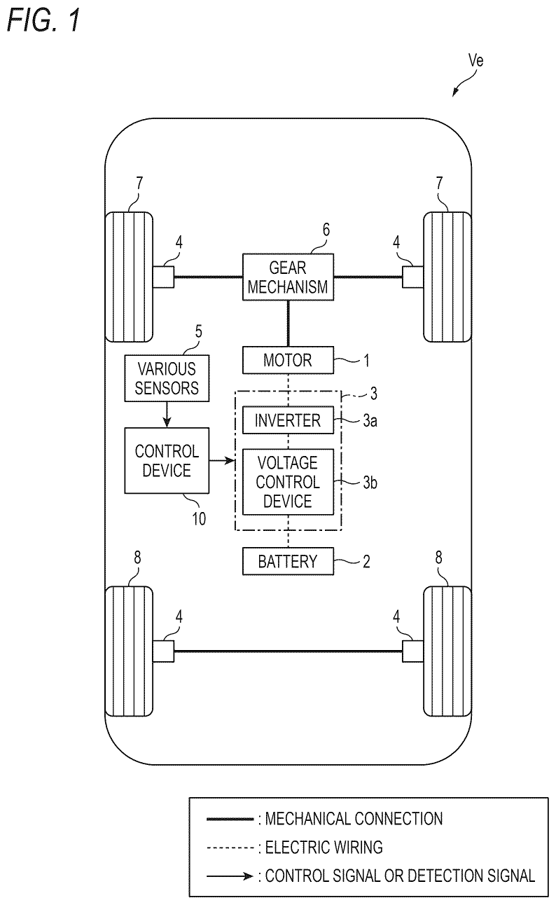

First, a configuration of the vehicle Ve that is a subject of the embodiment will be described. The vehicle Ve may be a vehicle Ve including the motor 1 as a drive source. Therefore, the vehicle Ve is assumed to be, for example, an electric automobile with only the motor 1 as the drive source, or a hybrid vehicle with an engine and the motor 1 as the drive sources. Further, regarding a drive type, the vehicle Ve may be a two-wheel drive vehicle having two front wheels or two rear wheels as drive wheels, a four-wheel drive vehicle having four wheels including front and rear wheels as drive wheels, or an all-wheel drive vehicle having all wheels as drive wheels. In the embodiment, as shown in FIG. 1, a front-wheel-drive electric automobile is shown as an example.

The vehicle Ve includes, as main components, the motor 1, a battery 2, a power conversion device 3, brake devices 4, various sensors 5, and a control device 10 that controls the vehicle Ve. In FIG. 1, thick solid lines indicate mechanical connections, broken lines indicate electrical wiring, and arrows indicated by thin solid lines indicate transmission and reception of control signals or detection signals.

The motor 1 is a motor generator used as a drive source and is implemented by, for example, a three-phase AC motor. The motor 1 is electrically connected to the battery 2 via the power conversion device 3. Electric power of the battery 2 can be supplied to the motor 1. The motor 1 operates as an electric motor when being supplied with electric power, and outputs power for causing the vehicle Ve to travel. The motor 1 is coupled to front wheels 7, which are drive wheels, via a gear mechanism 6 having a speed change function, and power output from the motor 1 is transmitted to the front wheels 7. In other words, the vehicle Ve can travel using the power output by the motor 1 when the electric power from the battery 2 is supplied to the motor 1. Reference numerals 8 shown in FIG. 1 denote rear wheels.

During braking of the vehicle Ve, the motor 1 functions as an electric generator by being rotated by the front wheels 7, which are drive wheels, and performs so-called regenerative power generation. Electric power generated by the regenerative operation of the motor 1 is supplied to the battery 2 via the power conversion device 3, for example. Thus, the battery 2 can be charged.

The power conversion device 3 is a so-called “power control unit” that converts received electric power and outputs the converted electric power, and is connected to the motor 1 and the battery 2. The power conversion device 3 includes an inverter 3a and a voltage control device 3b. The inverter 3a and the voltage control device 3b are electrically connected to each other.

The voltage control device 3b converts a received voltage and outputs the converted voltage. The voltage control device 3b may be, for example, a DC/DC converter. For example, in a case of supplying the electric power of the battery 2 to the motor 1, the voltage control device 3b boosts an output voltage of the battery 2 and outputs the boosted output voltage to the inverter 3a. Further, for example, when the regenerative power generation is performed by the motor 1, the voltage control device 3b steps down an output voltage of the motor 1 received via the inverter 3a and outputs the stepped down output voltage to the battery 2.

In the case of supplying the electric power of the battery 2 to the motor 1, the inverter 3a converts the electric power of the battery 2 received via the voltage control device 3b from DC to AC and outputs the converted electric power to the motor 1. When the regenerative power generation is performed by the motor 1, the inverter 3a converts the electric power received from the motor 1 from AC to DC and outputs the converted electric power to the voltage control device 3b.

The battery 2 is a chargeable and dischargeable secondary battery and includes a plurality of power storage cells connected in series or series-parallel. The battery 2 is configured to output a high voltage of, for example, 100 [V] to 400 [V]. A lithium-ion battery, a nickel-metal hydride battery, or the like may be used as the power storage cell of the battery 2.

The brake device 4 is a brake device that applies a braking force to the vehicle Ve and may have various configurations known in the related art. For example, the brake device 4 is implemented by an electric servo brake device including a brake caliper, a cylinder that transmits a hydraulic pressure to the brake caliper, and an electric motor that causes the cylinder to generate the hydraulic pressure (none is shown). The electric servo brake device brakes the vehicle Ve by the hydraulic pressure controlled according to an operation of a driver on the brake pedal. The electric servo brake device controls the electric motor according to a received operation amount on the brake pedal and outputs a braking torque corresponding to the braking operation to each wheel. The brake device 4 may be an electronically controlled hydraulic brake device, or the like.

The various sensors 5 include, for example, an accelerator position sensor that detects an operation amount on an accelerator pedal of the vehicle Ve, a brake position sensor that detects the operation amount on the brake pedal of the vehicle Ve, a rotation speed sensor or resolver that detects a rotation speed of the motor 1, a temperature sensor that detects a temperature of the motor 1, a current sensor that detects a current in a winding or the like of the motor 1, and a vehicle speed sensor that detects a vehicle speed that is a travel speed of the vehicle Ve. Detection results from the various sensors 5 are transmitted to the control device 10 as detection signals.

The control device 10 is, for example, a computer that includes a processor for performing various calculations, a storage unit including a non-transitory storage medium for storing various kinds of information such as predetermined maps and programs, and an input and output unit that controls input and output of data between inside and outside of the control device 10 (none is shown), and that controls the entire vehicle Ve. For example, the control device 10 is implemented by one electronic control unit (ECU) or by a plurality of ECUs working in cooperation with each other.

For example, the control device 10 is provided to be able to communicate with the power conversion device 3, the brake devices 4, and the various sensors 5. The control device 10 controls the output of the motor 1 by controlling the power conversion device 3 and controls the driving force of the vehicle Ve. Further, the control device 10 controls the braking force of the vehicle Ve by controlling the motor 1 and the brake devices 4.

The control device 10 executes, for example, various programs stored in the storage unit. In the related art, in an electric vehicle or the like, for example, there is known a control in which the vehicle Ve is stopped on an uphill road or a motor torque is output to such an extent that the vehicle Ve does not slip down to maintain a stopped state of the vehicle Ve. When such a stopped state continues, the motor 1 enters a stall state in which rotation of the motor 1 is substantially stopped even though the motor torque is output (hereinafter, also simply referred to as “stall state”). When entering the stall state, the motor 1 is caused to escape from the stall state by increasing or decreasing the motor torque, and the vehicle Ve is vibrated by increasing or decreasing the motor torque to make the user aware of the stall state.

However, since the control for applying vibration to the vehicle Ve by increasing or decreasing the motor torque is a behavior of the vehicle Ve that is not intended by the user, a frequency of the control is preferably low. Therefore, in the embodiment, a predetermined program is executed to enable escaping from the stall state while reducing the execution of the control for increasing or decreasing the motor torque.

Specifically, the control device 10 performs a program for torque control processing of determining, according to the temperature of the motor 1, a frequency of the control for increasing or decreasing the motor torque and performing a torque control of increasing or decreasing the motor torque according to the frequency (hereinafter, also simply referred to as “torque control”), as an example of the program recorded in the storage unit.

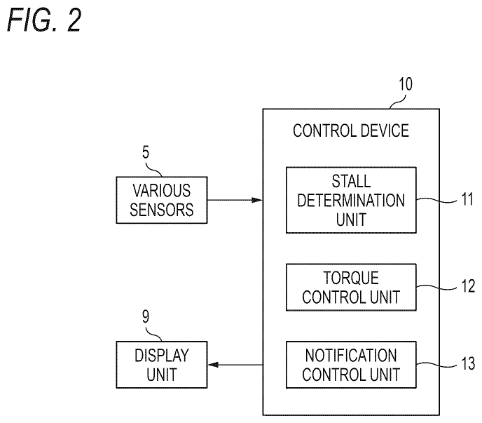

As shown in FIG. 2, the control device 10 includes a stall determination unit 11, a torque control unit 12, and a notification control unit 13 as functional units realized by executing the program. In the following, processing described as being performed by the stall determination unit 11, the torque control unit 12, and the notification control unit 13 are processing implemented by the control device 10.

Detection values from the various sensors 5 described above are input to the control device 10, and the control device 10 is configured to output a processed calculation result to, for example, a predetermined display unit 9. A specific content will be described later.

The stall determination unit 11 determines the stall state in which the motor 1 is not rotating in a state in which the motor torque is generated based on a drive instruction. For example, the stall determination unit 11 acquires the motor torque based on a current value detected by the current sensor. Further, the motor rotation speed detected by the rotation speed sensor is acquired. Based on the acquired motor torque and motor rotation speed, the stall determination unit 11 determines the stall state when the motor rotation speed is “0” or substantially “0” even though the motor torque is a predetermined torque, for example.

When the stall determination unit 11 determines that the motor 1 is in the stall state, the torque control unit 12 executes the torque control for controlling the motor torque to change a rotation angle of the motor 1. That is, since it is determined that the motor 1 is in the stall state, the torque control unit 12 executes the torque control by increasing or decreasing the motor torque to change the rotation angle of the motor 1 in order to enable escaping from the stall state.

Here, specific control contents of the “torque control” will be described. The torque control in the embodiment includes a torque decrease control for decreasing the motor torque to move the vehicle Ve rearward (hereinafter, simply referred to as “torque decrease control”), and a torque return control for returning the motor torque to that before the execution of the torque decrease control by increasing the motor torque by an amount decreased by the torque decrease control (hereinafter, simply referred to as “torque return control”). In the embodiment, when the stall state is determined, the torque return control is executed immediately after the torque decrease control is executed. At this time, as a behavior of the vehicle Ve, the vehicle Ve slips down from the stopped position due to the torque decrease control, and returns to the stopped position or a position substantially the same as the stopped position due to the torque return control. That is, the vehicle Ve is moved back and forth due to the torque control. When the vehicle Ve moves back and forth in this way, the vehicle Ve vibrates.

It is preferable that between a change rate of the motor torque in the torque decrease control and a change rate of the motor torque in the torque return control, the change rate of the motor torque in the torque decrease control is smaller. As described above, the vehicle Ve is moved rearward, so that the torque decrease control is executed to reduce the discomfort felt by the user due to the rearward movement of the vehicle Ve. In other words, the torque return control is set to be relatively larger in the change rate of the motor torque than the torque decrease control. This is because the torque return control is a control for returning the vehicle Ve to an original position where the vehicle is stopped, and by quickly returning the vehicle Ve that is moved rearward to the original position, there is a possibility that the discomfort given to the user can be reduced.

The torque control unit 12 preferably controls an increase rate of the motor torque such that the rotation angle of the motor 1 changes to a forward direction of the vehicle Ve at the end of the torque return control. This is to prevent the vehicle Ve from slipping down due to inertia of the vehicle Ve during the torque return control. That is, the torque control unit 12 determines the increase rate of the motor torque such that the motor rotation speed is overshot in a positive direction.

For example, the torque control unit 12 executes the torque control at a predetermined frequency instead of continuously executing the torque control until the user is aware of the stall state as in a control known in the related art. This is because, when the torque control is continuously executed, a slipping amount of the vehicle Ve increases.

As an example, the torque control unit 12 executes the torque control at a predetermined frequency based on the temperature of the motor 1. Specifically, the torque control unit 12 increases the frequency of executing the torque control as the temperature of the motor 1 increases. In other words, the torque control unit 12 decreases the frequency of the torque control when the temperature of the motor 1 is relatively low. The temperature of the motor 1 is, for example, a temperature of a winding of the motor 1.

More specifically, the torque control unit 12 records the temperature of the motor 1 when the stall state is determined as an initial temperature Th0, and executes the torque control when the temperature of the motor 1 rises and reaches a threshold Th1 (Th1>Th0). Then, when a predetermined operation on the brake pedal or the like for making the motor 1 escape from the stall state is not performed in the torque control, the torque control unit 12 executes the torque control again when the temperature of the motor 1 reaches a threshold Th2 (Th2>Th1). Further, in this state, when the predetermined operation on the brake pedal or the like for making the motor 1 escape from the stall state is also not performed, the torque control unit 12 executes the torque control again when the temperature of the motor 1 reaches a threshold Th3 (Th3>Th2). The torque control unit 12 executes the torque control until the temperature of the motor 1 reaches a predetermined upper limit temperature or until the predetermined operation for making the motor 1 escape from a stall state is performed.

Further, the torque control unit 12 reduces a temperature width of each threshold Th of the temperature of the motor 1 such that the frequency of executing the torque control increases as the temperature of the motor 1 increases. That is, between a temperature width from the initial temperature Th0 to the threshold Th1 and a temperature width from the threshold Th1 to the threshold Th2, the temperature width from the threshold Th1 to the threshold Th2 is smaller. In other words, the temperature width from the threshold Th1 to the threshold Th2 shows a smaller temperature rise. Further, between the temperature width from the threshold Th1 to the threshold Th2 and the temperature width from the threshold Th2 to the threshold Th3, the temperature width from the threshold Th2 to the threshold Th3 is smaller. As described above, the torque control unit 12 increases the frequency of executing the torque control by reducing the temperature width of the threshold Th of the temperature of the motor 1 that performs the torque control, as the temperature of the motor 1 increases. More detailed control contents will be described with reference to a time chart described later.

The torque control may be executed after the stall determination unit 11 determines the stall state, that is, when the temperature of the motor 1 is the initial temperature Th0, but in the embodiment, in order to limit the frequency of executing the torque control, the torque control is executed, for example, when the temperature of the motor 1 reaches the threshold Th1 after the stall state is determined.

In addition to the operation on the brake pedal, the predetermined operation for making the motor 1 escape from the stall state includes an operation of releasing a state in which the vehicle Ve is maintained in the stopped state by the motor torque, such as an operation of further depressing the accelerator pedal. In the following description, the predetermined operation for making the motor 1 escape from the stall state will be described as “operation on the brake pedal”. When the predetermined operation is performed, the torque control unit 12 ends the torque control.

In this way, escaping from the stall state is enabled by operating the brake pedal, but when the user switches the operation from the operation on the accelerator pedal to the operation on the brake pedal, an unavoidable depressing change time occurs. During the depressing change time, neither the accelerator pedal nor the brake pedal is operated, that is, the motor torque is a motor torque corresponding to an accelerator opening. Thus, the vehicle Ve may slip down greatly. Therefore, in the embodiment, a control for preventing the vehicle Ve from slipping down at the time of the depressing change from the accelerator pedal to the brake pedal is executed.

Specifically, the torque control unit 12 controls the motor torque at a change rate smaller than a change rate of the torque corresponding to a required driving force, at the time of the depressing change from the accelerator pedal to the brake pedal. That is, normally, the motor torque decreases at a change rate corresponding to accelerator OFF, but in the embodiment, the motor torque is controlled to decrease more slowly than the change rate corresponding to the accelerator OFF. Accordingly, the slipping amount of the vehicle Ve can be limited.

On the other hand, a timing at which the brake pedal is depressed by an operation of the user is not uniquely determined, and, for example, even if the brake pedal is depressed during the execution of the torque control, the brake pedal may be operated during the execution of the torque decrease control, or the brake pedal may be operated during the execution of the torque return control. Since the torque decrease control and the torque return control are different controls, it is preferable to execute the torque control corresponding to each control even at a switching timing of the drive instruction for switching the operation to the brake pedal from the accelerator pedal. Therefore, in the embodiment, different controls are executed between a control in a case where the depressing change from the accelerator pedal to the brake pedal is performed during the execution of the torque decrease control and a control in a case where the depressing change from the accelerator pedal to the brake pedal is performed during the execution of the torque return control.

In the case where the depressing change to the brake pedal is performed during the execution of the torque decrease control, the torque control unit 12 at least maintains a decrease rate of the motor torque in the torque decrease control in a state in which the accelerator pedal is depressed. This is because when the motor torque is controlled at a larger decrease rate, the vehicle Ve further slips down. Since the vehicle Ve is being moved rearward during the execution of the torque decrease control, it is preferable to control the motor torque at a lower change rate in order to minimize the slipping amount of the vehicle Ve. Therefore, the torque control unit 12 decreases the motor torque at a change rate smaller than the decrease rate of the motor torque in the torque decrease control in the state in which the accelerator pedal is depressed. In this way, even when the decrease rate of the motor torque is decreased, since the vehicle Ve is being moved rearward, the motor 1 is rotating, and an influence on a temperature rise of the motor 1 is relatively small. More detailed control contents will be described with reference to a time chart described later.

On the other hand, in the case where the depressing change to the brake pedal is performed during the execution of the torque return control, the torque control unit 12 continues the torque return control until the torque decreased by the torque decrease control is increased, and then decreases the motor torque. That is, the torque control unit 12 returns the motor torque to a balance torque at which the vehicle Ve is in the stopped state, and decreases the motor torque from that state. As described above, for example, since the change rate of the torque in the torque return control is larger than that in the torque decrease control, the torque return control is expected to last for a very short period of time. Therefore, it is expected that the user feels little discomfort even if the motor torque is returned until reaching the balance torque.

Then, when the motor torque returns to the balance torque, the torque control unit 12 decreases the motor torque, but regarding a decrease rate of the motor torque to be decreased at this time, the motor torque is decreased at a change rate, for example, at least smaller than the change rate of the motor torque corresponding to the accelerator OFF due to elimination of the required driving force and larger than the decrease rate in the torque decrease control. This is because it is possible to prevent the user from having an illusion that the torque decrease control is continued. Further, it is preferable that the change rate is larger than the decrease rate in the torque decrease control in order to provide a thermal margin.

Further, a timing at which the brake pedal is depressed by the operation of the user may be, in addition to during the execution of the torque decrease control or the torque return control, in a state in which the vehicle Ve is maintained in the stopped state while the motor torque is generated based on the drive instruction after the end of the torque return control. In the following description, a control in the state in which the stopped state of the vehicle Ve is maintained while generating the motor torque based on the drive instruction after the end of the torque return control is referred to as “torque balance control”. During execution of the torque balance control, it is also preferable to control the motor torque to prevent the vehicle Ve from slipping down at the time of the depressing change from the accelerator pedal to the brake pedal. Therefore, in the embodiment, when the required driving force is eliminated due to a change in the drive instruction during the execution of the torque balance control, the torque control unit 12 decreases the motor torque at a decrease rate smaller than the change rate of the motor torque corresponding to the accelerator OFF. The decrease rate of the motor torque at this time is a decrease rate different from the decrease rate in the torque decrease control described above and may be, for example, the same as the decrease rate of the motor torque in the case where the depressing change from the accelerator pedal to the brake pedal is performed during the torque return control. This is because it is possible to give the user an illusion that torque decrease control is continued, and further, it is possible to provide a thermal margin.

The notification control unit 13 notifies the user that the motor 1 is in the stall state. That is, when the stall determination unit 11 determines the stall state, for example, a warning notification indicating the stall state is issued on a predetermined display unit 9 such as an instrument panel or a navigation system. Alternatively, a predetermined warning sound may be generated to issue a warning notification to the user of the stall state. Further, in the embodiment, when the stall state is once determined and the notification is issued, the warning notification is continuously issued until the stall state is switched to a non-stall state. That is, by continuously issuing the warning notification until an operation of further depressing the brake pedal or the accelerator pedal is performed, the user is aware of the stall state earlier and is prompted to perform a predetermined operation on the brake pedal or the like.

### Time Chart

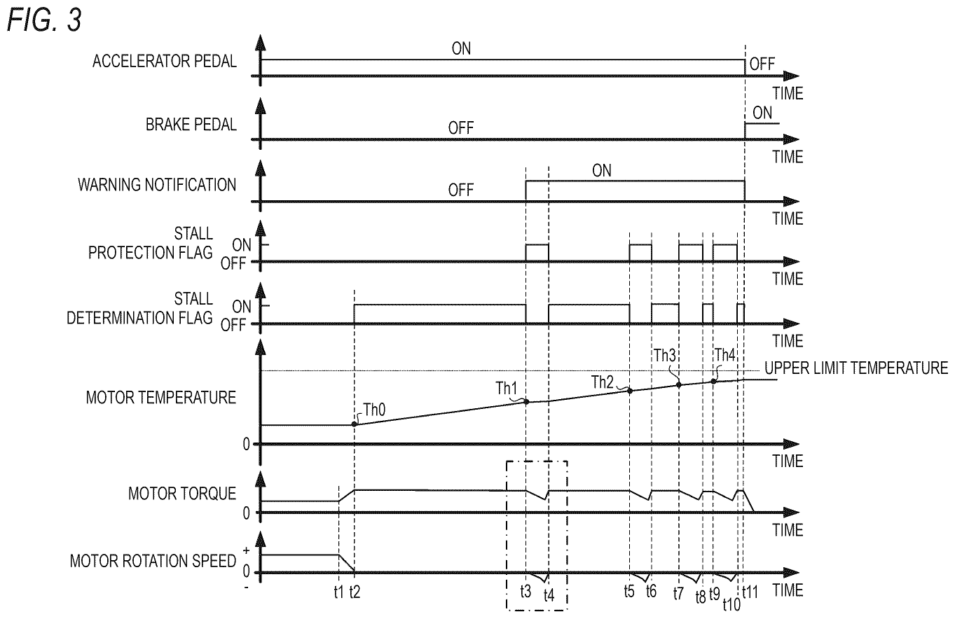

Next, an example of torque control processing executed by the control device 10 will be described with reference to a time chart. FIG. 3 is a time chart showing an example of the processing and the processing is executed, for example, when the motor 1 is in the stall state in the state in which the vehicle Ve is on an uphill road and is maintained in a stopped state by outputting a motor torque. In the example shown in FIG. 3, changes in the accelerator pedal, the brake pedal, the warning notification, a stall protection flag, a stall determination flag, the motor temperature, the motor torque, and the motor rotation speed are shown, and these parameters are shown on a vertical axis. A horizontal axis represents time. The stall protection flag is a flag for starting the above-described torque control when the stall state is determined, and the torque control is executed when the stall protection flag is ON.

Specifically, first, until a time point t1, the user operates the accelerator pedal on the uphill road to output a predetermined motor torque, and thereby the vehicle Ve is maintained in a stopped state. Therefore, from a time point to to the time point t1, the motor torque and the motor rotation speed are constant. The temperature of the motor 1 is a predetermined temperature that is relatively lower than an upper limit temperature at which the torque is limited (hereinafter, also simply referred to as “upper limit temperature”). The other parameters, that is, the brake pedal, the warning notification, the stall protection flag, and the stall determination flag are OFF.

At the time point t1, the motor torque rises. This may occur, for example, in a situation in which the vehicle Ve slightly slips down even though the predetermined motor torque is continuously output, and the user performs an operation of further depressing the accelerator pedal to maintain the stopped state. On the other hand, the motor rotation speed starts to decrease relative to the increase of the motor torque.

Then, at a time point t2, the motor rotation speed becomes “0” or substantially “0”, and thus the stall determination flag is set to ON by the stall determination unit 11. The temperature of the motor 1 when the stall determination flag is set to ON, that is, when the stall state is determined is defined as the initial temperature Th0.

At the time point t2, the stall state is determined, but the stall protection flag remains OFF. This is to prevent excessive torque control caused by setting the stall protection flag to ON because the temperature of the motor 1 is relatively lower than, for example, the upper limit temperature in the stall state. In other words, this is to prevent an occurrence of a behavior of the vehicle Ve such as a front-rear movement unintended by the user when the torque control is executed.

Further, at the time point t2, the motor 1 is not rotating, and thus the temperature of the motor 1 starts to rise due to, for example, a current continuously flowing in a specific phase.

Then, at a time point t3, the temperature of the motor 1 that starts to rise at the time point t2 reaches the threshold Th1. In response, the stall determination unit 11 sets the stall protection flag to ON. Then, when the stall protection flag is set to ON, the torque control unit 12 performs the torque control described above.

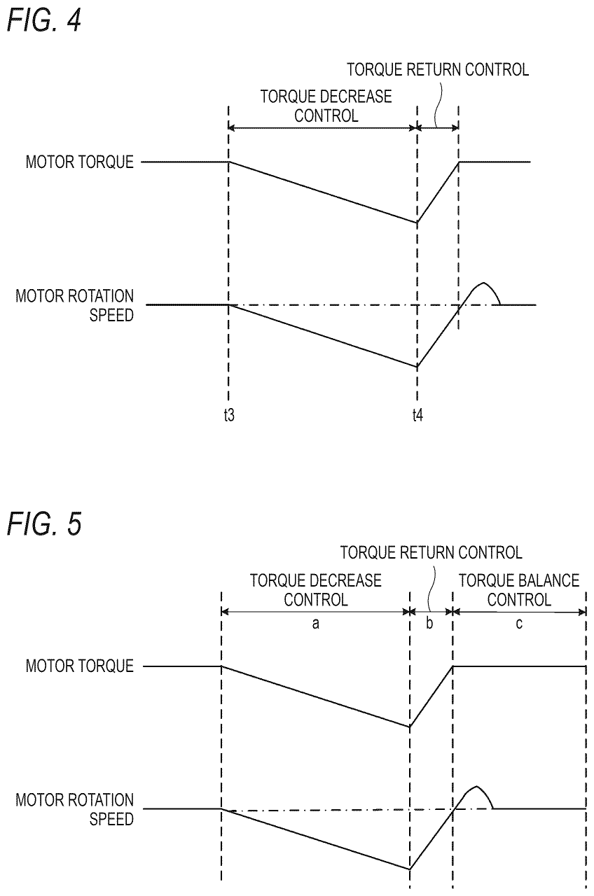

Specifically, the torque control unit 12 performs the torque decrease control and the torque return control from the time point t3 to a time point t4. At this time, the torque control unit 12 reduces the slipping amount of the vehicle Ve during the torque decrease control by making the change rate of the torque in the torque return control larger than the change rate of the torque in the torque decrease control. The torque control unit 12 controls the increase rate of the motor torque such that the rotation angle of the motor 1 changes to the forward direction of the vehicle Ve at the end of the torque return control. FIG. 4 is an enlarged diagram from the time point t3 to the time point t4 surrounded by a one-dot chain line in FIG. 3. As shown in FIG. 4, the torque control unit 12 determines the increase rate of the motor torque such that the motor rotation speed is overshot in a positive direction at the end of the torque return control.

By executing the torque decrease control and the torque return control, the vehicle Ve is moved back and forth, and the motor rotation speed changes accordingly, that is, the rotation angle of the motor 1 changes, so that the stall determination flag is set to OFF.

When the stall protection flag is set to ON at the time point t3, the notification control unit 13 issues a warning notification. As described above, the warning notification may be issued in an appropriate method such as displaying the warning notification on the predetermined display unit 9 or generating a warning sound. In the example shown in FIG. 3, an ON state of the warning notification is maintained until the brake pedal is operated. That is, in the example of FIG. 3, during the execution of the torque decrease control and the torque return control, the stall determination flag is set to OFF, but the drive instruction is not changed from the accelerator pedal to the brake pedal, and there is a high possibility that the user is not aware of the stall state or a state close to the stall state, and thus the warning notification is continuously issued.

The temperature of the motor 1 from the time point t3 to the time point t4 gradually rises or does not substantially change as the motor 1 is rotated by the torque decrease control and the torque return control.

Next, at the time point t4, the torque decrease control and the torque return control end, and the stall protection flag is set to OFF. On the other hand, when the torque control is executed, the vehicle Ve is moved back and forth, and the vehicle Ve vibrates, but at the time point t4, the operation on the brake pedal is in an OFF state. That is, there is a high possibility that the user is not aware of the stall state. Then, the motor rotation speed is “0” again, and the temperature of the motor 1 is also equal to or higher than the threshold Th1. Therefore, at the time point t4, the stall determination flag is set to ON again.

As in the control known in the related art, for example, when the stall protection flag is set to ON, it may also be assumed that the torque decrease control and the torque return control are continuously executed until the user is aware of the stall state, but when such torque control is continued, the slipping amount of the vehicle Ve continues to increase, and thus the torque control is executed at a predetermined frequency in the embodiment.

Then, when the motor 1 enters the stall state again, the temperature of the motor 1 further rises. When the temperature of the motor 1 continues to rise, the temperature of the motor 1 reaches the threshold Th2 (a time point t5). When the temperature of the motor 1 reaches the threshold Th2, the stall protection flag is set to ON again, and the torque decrease control and the torque return control are executed. When the torque decrease control and the torque return control are executed, the motor rotation speed changes and the stall determination flag is set to OFF (a time point t6).

As described above, in the embodiment, as the temperature of the motor 1 increases, the frequency of executing the torque decrease control and the torque return control increases. Therefore, a time change from when the stall determination flag is set to ON to when the stall protection flag is set to ON is shorter from the time point t4 to the time point t5 than from the time point t2 to the time point t3. Further, a temperature change from when the stall determination flag is set to ON to when the stall protection flag is set to ON is smaller from the time point t4 to the time point t5 than from the time point t2 to the time point t3.

Then, at the time point t6, the torque decrease control and the torque return control end, the stall protection flag is again set to OFF, and the stall determination flag is set to ON as the motor rotation speed becomes “0”.

In the control executed after the time point t6, the torque decrease control and the torque return control are repeatedly executed each time the temperature of the motor 1 reaches a predetermined threshold (for example, the threshold Th3, the threshold Th4, . . . ). For example, a control from the time point t6 to a time point t8 is a control similar to the control from the time point t4 to the time point t6. For example, a control from the time point t8 to a time point t10 is also a control similar to the control from the time point t4 to the time point t6. Therefore, a description of the control from the time point t6 to the time point t10 in the time chart of FIG. 3 will be omitted. For example, in a case where the brake pedal is operated during this period, the torque control is ended.

As the temperature of the motor 1 rises, an interval of the threshold Th decreases. This is because the temperature of the motor 1 approaches the upper limit temperature as the temperature of the motor 1 rises, and thus the frequency of executing the torque control is increased to make the user aware of the stall state.

In the example of FIG. 3, the accelerator pedal is OFF and the brake pedal is ON at a time point t11. Therefore, at the time point t11, the stall determination flag in the ON state is set to OFF, and the warning notification is also OFF. That is, at the time point t11, a change of the drive instruction from the accelerator pedal to the brake pedal is made, escaping from the stall state is completed, and the torque control executed at a predetermined frequency ends.

At the time point t11, the brake pedal is operated, and thus the motor torque decreases as quickly as possible.

Next, a control example for preventing the vehicle Ve from slipping down at the time of the depressing change from the accelerator pedal to the brake pedal will be described.

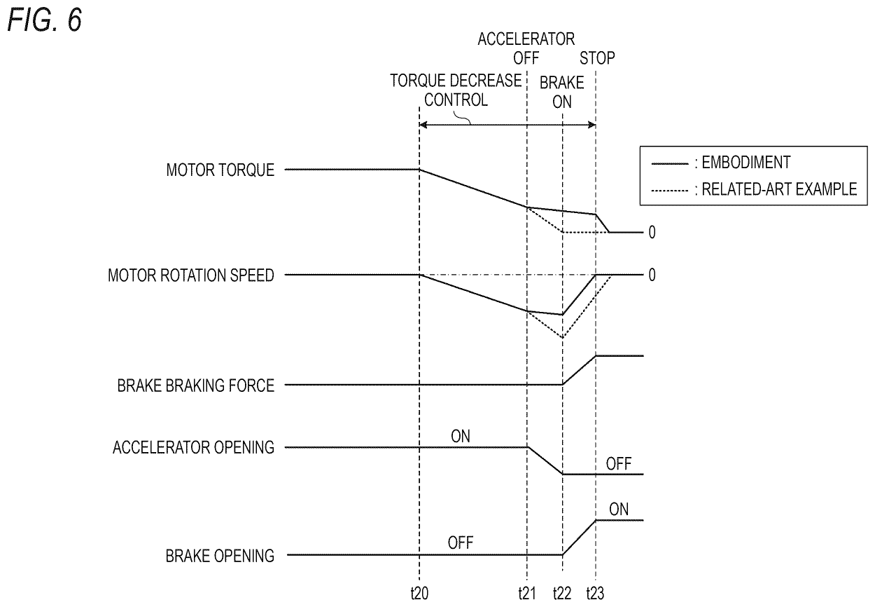

FIG. 5 is an enlarged diagram showing a timing at which the depressing change from the accelerator pedal to the brake pedal may be performed, in which a region indicated by “a” indicates a region in which the torque decrease control is executed, a region indicated by “b” indicates a region in which the torque return control is executed, and a region indicated by “c” indicates a region in which the torque balance control is executed. That is, the depressing change from the accelerator pedal to the brake pedal may be performed when any torque control is executed. Since the example shown in FIG. 5 shows a relationship between the timing of the depressing change to the brake pedal and each torque control, the motor torque and the motor rotation speed are representatively shown as parameters shown on a vertical axis. Hereinafter, changes in the motor torque, the motor rotation speed, a brake braking force, the accelerator opening, and a brake opening in a case where the depressing change to the brake pedal is performed during the execution of each torque control will be described with reference to FIGS. 6 to 8.

FIG. 6 is an example of a case where the depressing change to the brake pedal is performed during the execution of the torque decrease control indicated by “a” in FIG. 5. Solid lines each indicate a change in the corresponding parameter in the embodiment, and broken lines each indicate a change in the corresponding parameter in a related-art example.

At a time point t20, the execution of the torque decrease control is started. That is, as described in the time chart of FIG. 3, when the temperature of the motor 1 reaches the predetermined threshold Th, the stall protection flag is set to ON, and the torque decrease control is executed.

In this state, for example, at a time point t21, it is assumed that the user performs the depressing change from the accelerator pedal to the brake pedal. Specifically, at the time point t21, an accelerator OFF operation in which the user releases his/her foot from the accelerator pedal is performed. Therefore, at the time point t21, the accelerator opening starts to decrease. Normally, as shown in the related-art example, the motor torque and the motor rotation speed rapidly decrease at a change rate corresponding to the decrease of the accelerator opening, as the accelerator OFF operation is performed.

However, when the motor torque and the motor rotation speed rapidly decrease, as the behavior of the vehicle Ve, the vehicle Ve that is gradually moved rearward due to the torque decrease control rapidly slips down since the torque decrease control is ended by the accelerator OFF operation. Therefore, in the embodiment, in order to prevent such slipping down, the motor torque is decreased at a predetermined decrease rate until the brake pedal is ON and the brake braking force generated by the brake device 4 reaches a value for stopping the vehicle Ve. In other words, the torque decrease control is continued until the brake braking force reaches the value for stopping the vehicle Ve. The decrease rate of the motor torque at this time is preferably set to be further smaller in change rate than, for example, the decrease rate up to the time point t21. This is because the slipping amount of the vehicle Ve can be further reduced.

Then, at a time point t22, the brake pedal is depressed. Thus, the brake opening starts to increase, and the brake braking force also starts to increase. Further, in the example shown in FIG. 6, the accelerator opening that starts to decrease at the time point t21 gets to an OFF state, that is, “O” at the time point t22. Accordingly, the motor torque in the related-art example is also “0”. On the other hand, in the embodiment, at the time point t22, since the brake braking force does not increase to the value for maintaining the stopped state of the vehicle Ve, the motor torque decreases at the predetermined decrease rate, and the torque decrease control is continuously executed.

Then, at a time point t23, the brake braking force becomes a braking force at which the vehicle Ve is stopped. Therefore, the control on the motor torque ends, and the motor torque decreases toward “0”. Accordingly, the motor rotation speed also becomes “0”.

In this way, in the case where the depressing change to the brake pedal is performed during the execution of the torque decrease control, the torque decrease control is executed until the brake braking force reaches the value for maintaining the stopped state of the vehicle Ve, and thus it is possible to minimize the slipping amount of the vehicle Ve at the time of the depressing change from the accelerator pedal to the brake pedal.

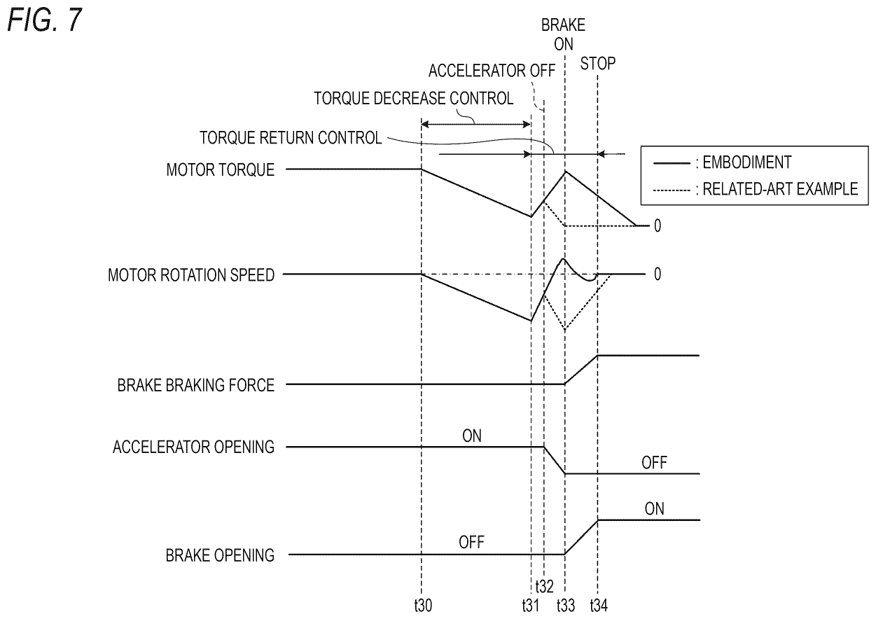

FIG. 7 is an example of a case where the depressing change to the brake pedal is performed during the execution of the torque return control indicated by “b” in FIG. 5. Solid lines each indicate a change in the corresponding parameter in the embodiment, and broken lines each indicate a change in the corresponding parameter in the related-art example.

From a time point t30 to a time point t31, the torque decrease control is being executed. Then, at the time point t31, the execution of the torque return control is started.

In this state, for example, at a time point t32, it is assumed that the user performs the depressing change from the accelerator pedal to the brake pedal. Specifically, at the time point t32, the accelerator OFF operation in which the user releases his/her foot from the accelerator pedal is performed. Therefore, at the time point t32, the accelerator opening starts to decrease. Normally, as shown in the related-art example, the motor torque and the motor rotation speed rapidly decrease at a change rate corresponding to the decrease of the accelerator opening, as the accelerator OFF operation is performed.

However, when the motor torque and the motor rotation speed rapidly decrease, as the behavior of the vehicle Ve, the vehicle Ve rapidly slips down due to the torque return control being ended by the accelerator OFF operation. Therefore, in the embodiment, at the time point t32, in order to prevent such slipping down, the motor torque is output until the brake braking force generated by the brake device 4 reaches the value for stopping the vehicle Ve. In other words, the torque return control is continued until the brake braking force reaches the value for stopping the vehicle Ve, that is, the balance torque is reached. The increase rate of the motor torque at this time may be, for example, an increase rate similar to that of the torque return control from the time point t31 to the time point t32.

Then, at a time point t33, the motor torque reaches the balance torque. In the example shown in FIG. 7, the brake pedal is depressed at the time point t33. Thus, the brake opening starts to increase, and the brake braking force also starts to increase. Further, in the example shown in FIG. 7, the accelerator opening that starts to decrease at the time point t32 gets to an OFF state, that is, “0” at the time point t33. Accordingly, the motor torque in the related-art example is also “0”. The motor rotation speed at the time point t33 is a positive value due to the overshooting described above.

Then, at the time point t33, the motor torque starts to decrease. Normally, since the brake is ON and the accelerator opening is “0”, the motor torque decreases as quickly as possible, but at the time point t33, the brake braking force does not increase to the value for maintaining the vehicle Ve at the stopped state. Therefore, in the embodiment, for example, the torque control unit 12 decreases the motor torque at a change rate smaller than the change rate of the motor torque corresponding to the accelerator OFF due to the elimination of the required driving force and larger than the decrease rate in the torque decrease control. Thus, it is possible to prevent the user from having an illusion that the torque decrease control is continued. Further, it is possible to provide a thermal margin.

Then, at a time point t34, the brake braking force becomes a braking force at which the vehicle Ve is stopped. Therefore, the control on the motor torque ends, and the motor torque decreases toward “0”. Accordingly, the motor rotation speed also becomes “0”.

In this way, when the depressing change to the brake pedal is performed during the execution of the torque return control, the torque control is executed until the brake braking force reaches the value for maintaining the stopped state of the vehicle Ve, and thus it is possible to minimize the slipping amount of the vehicle Ve at the time of the depressing change from the accelerator pedal to the brake pedal.

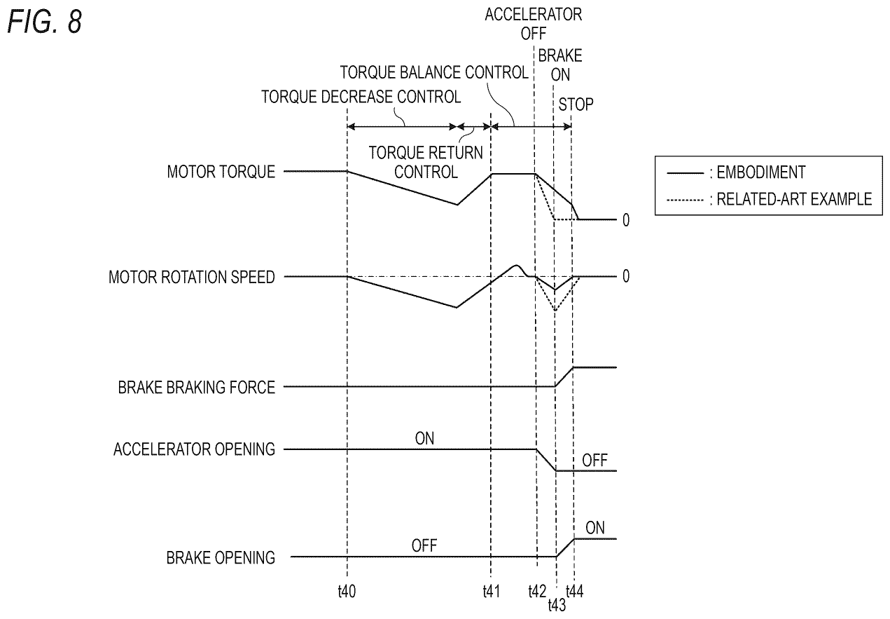

FIG. 8 is an example of a case where the depressing change to the brake pedal is performed during the execution of the torque balance control indicated by “c” in FIG. 5. Solid lines each indicate a change in the corresponding parameter in the embodiment, and broken lines each indicate a change in the corresponding parameter in the related-art example.

From a time point t40 to a time point t41, the torque decrease control and the torque return control are being executed. Then, at the time point t41, the execution of the torque balance control is started.

In this state, for example, at a time point t42, it is assumed that the user performs the depressing change from the accelerator pedal to the brake pedal. Specifically, at the time point t42, the accelerator OFF operation in which the user releases his/her foot from the accelerator pedal is performed. Therefore, at the time point t42, the accelerator opening starts to decrease. Normally, as shown in the related-art example, the motor torque and the motor rotation speed rapidly decrease at a change rate corresponding to the decrease of the accelerator opening, as the accelerator OFF operation is performed.

However, when the motor torque and the motor rotation speed rapidly decrease, as the behavior of the vehicle Ve, the vehicle Ve rapidly slips down due to the torque balance control being ended by the accelerator OFF operation. Therefore, in the embodiment, at the time point t42, in order to prevent such slipping down, the motor torque is decreased at a predetermined decrease rate until the brake braking force generated by the brake device 4 reaches the value for stopping the vehicle Ve. Regarding the decrease rate of the motor torque at this time, for example, the motor torque is decreased at a change rate smaller than the change rate of the motor torque corresponding to the accelerator OFF due to the elimination of the required driving force and larger than the decrease rate in the torque decrease control. Thus, the vehicle Ve can be prevented from slipping down while the brake braking force is increasing to the value for maintaining the stopped state.

Then, at a time point t43, the brake pedal is depressed. Thus, the brake opening starts to increase, and the brake braking force also starts to increase. Further, in the example shown in FIG. 8, the accelerator opening that starts to decrease at the time point t42 gets to an OFF state, that is, “0” at the time point t43. Accordingly, the motor torque in the related-art example is also “0”. At the time point t43, since the brake braking force has not increased to the value for maintaining the stopped state of the vehicle Ve, the execution of the control for decreasing the motor torque from the time point t42 is continued, and therefore, the motor torque decreases at a predetermined decrease rate.

Then, at a time point t44, the brake braking force becomes a braking force at which the vehicle Ve is stopped. Therefore, the control on the motor torque ends, and the motor torque decreases toward “0”. Accordingly, the motor rotation speed also becomes “0”.

In this way, when the depressing change to the brake pedal is performed during the execution of the torque balance control, the torque control is executed until the brake braking force reaches the value for maintaining the stopped state of the vehicle Ve, and thus it is possible to minimize the slipping amount of the vehicle Ve at the time of the depressing change from the accelerator pedal to the brake pedal.

As described above, in the embodiment, when the stall state is determined, by executing the torque control at a predetermined frequency, the vehicle Ve slips down or moves back and forth due to a change in the torque caused by the torque control, so that it is possible to prompt the user to operate the brake pedal or the like, thereby avoiding the stall state.

Further, since the torque control is performed at a predetermined frequency based on the temperature of the motor, for example, as compared with a case where the torque control is continuously executed until the user is aware of the stall state, the slipping amount of the vehicle Ve can be reduced or a possibility that the user feels discomfort due to the continuous execution of the torque control can be reduced. That is, escaping from the stall state is enabled while limiting the frequency of increasing or decreasing the motor torque.

In the embodiment, as the temperature of the motor 1 increases, the frequency of torque control is increased. In other words, when the temperature of the motor 1 is relatively low, the frequency of executing the torque control is low. Therefore, for example, when the temperature of the motor 1 is high, the frequency of executing the torque control increases, thus a possibility that the user operates the brake pedal or the like increases, and therefore, escaping from the stall state is enabled and the temperature of the motor 1 can be prevented from reaching the upper limit temperature at which the torque is limited. On the other hand, when the temperature of the motor 1 is low, the frequency of executing the torque control is relatively low, thus the slipping down of the vehicle Ve and the front-rear movement of the vehicle Ve due to the torque control can be reduced, and the discomfort given to the user due to the behavior of the vehicle Ve can be reduced.

Further, in the embodiment, for example, in response to the motor being switched from the stall state to the non-stall state due to a change in the drive instruction such as a change from an operation on the accelerator pedal to an operation on the brake pedal, the torque control is ended. Therefore, for example, in a case where the torque control is ended in a state in which there is no drive instruction, there is a possibility that the vehicle Ve slips down, but by ending the torque control based on the drive instruction, the possibility that the vehicle Ve slips down can be avoided or prevented.

Further, in the embodiment, the torque control includes the torque decrease control and the torque return control, and the torque decrease control and the torque return control are different in the decrease rate of the motor torque when the depressing change from the accelerator pedal to the brake pedal is performed during the execution of each control. That is, in a normal control, in the case where the depressing change from the accelerator pedal to the brake pedal is performed during the torque control, the motor torque becomes one corresponding to the accelerator opening due to the accelerator OFF, so that the motor torque rapidly decreases and the vehicle Ve slips down. On the other hand, in the embodiment, by changing the decrease rate of the motor torque according to the timing of the torque decrease control or the torque return control, it is possible to prevent the vehicle Ve from slipping down at the time of the depressing change from the accelerator pedal to the brake pedal, and by executing the control on the motor torque at different decrease rates, it is possible to reduce the possibility that the user has an illusion that the torque decrease control is being executed during the execution of the torque return control, for example.

Further, in the embodiment, in the case where the depressing change from the accelerator pedal to the brake pedal is performed during the execution of the torque decrease control, the decrease rate of the torque corresponding to the decrease of the required driving force is smaller than the decrease rate of the torque in the torque decrease control. That is, when the brake pedal is operated during the execution of the torque decrease control, normally, the motor torque becomes one corresponding to the accelerator OFF, the motor torque rapidly decreases, and the vehicle Ve slips down, but by setting the decrease rate of the motor torque to be smaller than the decrease rate during the execution of the torque decrease control, in other words, by setting the decrease rate to be gentle, it is possible to prevent the vehicle Ve from slipping down at the time of the depressing change from the accelerator pedal to the brake pedal.

In the embodiment, the increase rate of the motor torque is determined such that the rotation angle of the motor changes to the forward direction of the vehicle Ve at the end of the torque return control. That is, at the end of the torque return control, the motor rotation speed is overshot to a forward rotation side. Thus, for example, it is possible to prevent the vehicle Ve from slipping down due to the inertia of the vehicle Ve during the torque return control.

Further, in the embodiment, in the case where the depressing change from the accelerator pedal to the brake pedal is performed during the execution of the torque return control, the torque return control is continued until the motor torque decreased by the torque decrease control is increased. That is, the motor torque is increased until the motor torque returns to the balance torque that maintains the stopped state of the vehicle Ve. Thus, for example, as compared with a case where the torque return control is ended in a state in which the motor torque is not returned to the balance torque at the time of the depressing change from the accelerator pedal to the brake pedal during the execution of the torque return control, it is possible to prevent the vehicle Ve from slipping down at the time of the depressing change from the accelerator pedal to the brake pedal.

Further, in the embodiment, in the case where the depressing change from the accelerator pedal to the brake pedal is performed during the execution of the torque balance control for maintaining the stopped state of the vehicle Ve after the torque return control is ended, the motor torque is decreased at a change rate smaller than the change rate of the motor torque corresponding to the accelerator OFF and larger than the decrease rate in the torque decrease control, for example. Thus, for example, in the case where the depressing change from the accelerator pedal to the brake pedal is performed during the execution of the torque balance control after the torque return control is ended, it is possible to prevent the vehicle Ve from slipping down at the time of the depressing change. Then, by controlling the motor torque at a decrease rate different from the decrease rate in the torque decrease control, for example, it is possible to reduce the possibility that the user has an illusion that the torque decrease control is being executed.

In the embodiment, the change rate of the motor torque in the torque decrease control is smaller than the change rate of the motor torque in the torque return control. In other words, the change rate of the motor torque in the torque return control is relatively larger than the change rate of the motor torque in the torque decrease control. Thus, since the change rate of the motor torque is small during the execution of the torque decrease control, it is possible to limit the slipping down of the vehicle Ve, thereby reducing the discomfort or the like given to the user. On the other hand, since the change rate of the motor torque is large during the execution of the torque return control, the vehicle Ve can be returned to the original position or the like at an early stage, so that the user can feel a sense of security.

Further, in the embodiment, after the stall state is determined, the notification is continuously issued on the predetermined display unit 9 until the stall state is switched to the non-stall state due to a change in the drive instruction such as a change from the operation on the accelerator pedal to the operation on the brake pedal. Since such a continuous notification is issued, it can be expected that, for example, when the motor 1 is temporarily out of the stall state, as compared with a case where the notification is stopped, the user operates the brake pedal or the like more quickly, and escaping from the stall state is enabled.

### Modification

Next, a modification will be described. In the embodiment described above, the temperature of the winding of the motor 1 is used as an example of the temperature of the motor 1, but the temperature is not limited to the temperature of the winding of the motor 1 as long as the temperature of the motor 1 can be detected. For example, a temperature of a rotor or a stator constituting the motor 1, a temperature of a surface of a motor case, or the like may be used. Alternatively, a temperature of the inverter 3a may be used as the temperature of the motor 1.

Further, in the embodiment described above, in the case where the depressing change from the accelerator pedal to the brake pedal is performed during the torque return control, the motor torque is increased until reaching the balance torque for maintaining the stopped state of the vehicle Ve. On the other hand, when the brake pedal is operated while the motor torque is increasing to the balance torque, the control for increasing the motor torque may be ended at a time point when the brake pedal is operated even if the motor torque is not increased to the balance torque. This is because it is possible to prevent the vehicle Ve from slipping down by operating the brake pedal.

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

The control described in the above embodiment may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present description, at least the following matters are described. Although corresponding constituent elements in the embodiment described above are shown in parentheses, the present disclosure is not limited thereto.

(1) A control device (control device 10) for a vehicle (vehicle Ve) including a motor (motor 1) as a drive source, the control device including:
a stall determination unit (stall determination unit 11) configured to determine a stall state of the motor in which the motor is not rotating, in a state in which a torque of the motor is generated based on a drive instruction; and
a torque control unit (torque control unit 12) configured to perform a torque control for controlling the torque to change a rotation angle of the motor in response to the motor being determined to be in the stall state, in which
the torque control unit performs the torque control at a predetermined frequency based on a temperature of the motor.

According to (1), for example, as compared with a case where the torque control is continuously executed until a user is aware of the stall state, a slipping amount of the vehicle can be reduced or a possibility that the user feels discomfort due to the continuous execution of the torque control can be reduced. That is, escaping from the stall state is enabled while limiting the frequency of increasing or decreasing the torque of the motor.

(2) The control device for a vehicle according to (1), in which
the torque control unit increases the frequency of executing the torque control as the temperature of the motor increases.

According to (2), when the temperature of the motor is relatively high, the user can be aware of the stall state easily. That is, since an output of the motor is limited to protect the motor when the temperature of the motor reaches an upper limit temperature, the frequency of the torque control increases. On the other hand, when the motor temperature is relatively low, the frequency of the torque control is relatively low, so that it is possible to reduce discomfort or the like given to the user due to vibration of the vehicle or the like.

(3) The control device for a vehicle according to (1), in which
the torque control unit ends the torque control in response to the motor being switched from the stall state to a non-stall state due to a change in the drive instruction.

According to (3), for example, in a case where the torque control is ended in a state in which there is no drive instruction, there is a possibility that the vehicle slips down, but by ending the torque control based on the drive instruction, the possibility that the vehicle slips down can be avoided or prevented.

(4) The control device for a vehicle according to (1), in which
the torque control includes a torque decrease control for decreasing the torque to move the vehicle rearward and a torque return control for increasing the torque by an amount decreased by the torque decrease control, and
in response to a required driving force being eliminated due to a change in the drive instruction while the torque control is being performed, the torque control unit performs a control such that a decrease rate of the torque to be decreased according to a timing of the change in the drive instruction in the torque decrease control is different from a decrease rate of the torque to be decreased according to a timing of the change in the drive instruction in the torque return control.

According to (4), it is possible to prevent the slipping down of the vehicle by the change in the drive instruction such as a depressing change from the accelerator pedal to the brake pedal, and a possibility that the user has an illusion that the torque decrease control is being executed during the execution of the torque return control can be reduced, for example, by controlling the torque of the motor at different decrease rates.

(5) The control device for a vehicle according to (4), in which
in response to the required driving force being eliminated due to the change in the drive instruction while the torque decrease control is being performed, the torque control unit sets a decrease rate of the torque corresponding to a decrease in the required driving force to be smaller than a decrease rate of the torque in the torque decrease control.

According to (5), for example, it is possible to prevent the vehicle from slipping down by the change in the drive instruction such as the depressing change from the accelerator pedal to the brake pedal.

(6) The control device for a vehicle according to (4) or (5), in which
the torque control unit determines an increase rate of the torque such that the rotation angle of the motor changes to a forward direction of the vehicle in response to the torque return control being ended.

According to (6), for example, it is possible to prevent the vehicle from slipping down due to inertia of the vehicle during the torque return control.

(7) The control device for a vehicle according to (4) or (5), in which
in response to the required driving force being eliminated due to the change in the drive instruction during execution of the torque return control, the torque control unit continues the torque return control until a decreased amount of the torque is increased.

According to (7), for example, in a case where the change in the drive instruction such as the depressing change from the accelerator pedal to the brake pedal is performed during the execution of the torque return control, as compared with a case where the torque return control is ended in a state in which the torque is not returned to a balance torque, it is possible to prevent the vehicle Ve from slipping down at the time of the depressing change from the accelerator pedal to the brake pedal.

(8) The control device for a vehicle according to (4), in which
the torque control further includes, after the torque return control is ended, a torque balance control for maintaining a stopped state of the vehicle in a state in which the torque is generated based on the drive instruction,
the torque control unit decreases the torque at a predetermined decrease rate in response to the required driving force being eliminated due to the change in the drive instruction while the torque balance control is being performed, and the decrease rate is different from the decrease rate in the torque decrease control.

According to (8), for example, in a case where the change in the drive instruction such as the depressing change from the accelerator pedal to the brake pedal is performed during the execution of the torque balance control after the torque return control is ended, it is possible to prevent the vehicle from slipping down at the time of the depressing change. Then, by controlling the motor torque at a decrease rate different from the decrease rate in the torque decrease control, for example, it is possible to reduce the possibility that the user has an illusion that the torque decrease control is being executed.

(9) The control device for a vehicle according to (1), in which
the torque control includes a torque decrease control for decreasing the torque to move the vehicle rearward and a torque return control for increasing the torque by an amount decreased by the torque decrease control, and
a change rate of the torque in the torque decrease control is smaller than a change rate of the torque in the torque return control.

According to (9), since the change rate of the torque of the motor is small during the execution of the torque decrease control, for example, it is possible to prevent the vehicle Ve from slipping down, thereby reducing the discomfort or the like given to the user. On the other hand, since the change rate of the torque of the motor is large during the execution of the torque return control, the vehicle can be returned to an original position or the like at an early stage, so that the user can be given a sense of security.

(10) The control device for a vehicle according to (1), further including
a notification control unit (notification control unit 13) configured to issue a notification of the stall state, in which
the notification control unit continuously issues the notification until the stall state is switched to a non-stall state due to a change in the drive instruction.

According to (10), for example, when the motor is temporarily out of the stall state, the user operates the brake pedal or the like more quickly, and escaping from the stall state is enabled, as compared with a case where the notification of the stall state is stopped.

What is claimed is:

1. A control device for a vehicle including a motor as a drive source, the control device comprising:
a stall determination unit configured to determine a stall state of the motor in which the motor is not rotating, in a state in which a torque of the motor is generated based on a drive instruction; and
a torque control unit configured to perform a torque control for controlling the torque to change a rotation angle of the motor in response to the motor being determined to be in the stall state, wherein
the torque control unit performs the torque control at a predetermined frequency based on a temperature of the motor.

2. The control device for a vehicle according to claim 1, wherein
the torque control unit increases the frequency of executing the torque control as the temperature of the motor increases.

3. The control device for a vehicle according to claim 1, wherein
the torque control unit ends the torque control in response to the motor being switched from the stall state to a non-stall state due to a change in the drive instruction.

4. The control device for a vehicle according to claim 1, wherein
the torque control includes a torque decrease control for decreasing the torque to move the vehicle rearward and a torque return control for increasing the torque by an amount decreased by the torque decrease control, and
in response to a required driving force being eliminated due to a change in the drive instruction while the torque control is being performed, the torque control unit performs a control such that a decrease rate of the torque to be decreased according to a timing of the change in the drive instruction in the torque decrease control is different from a decrease rate of the torque to be decreased according to a timing of the change in the drive instruction in the torque return control.

5. The control device for a vehicle according to claim 4, wherein
in response to the required driving force being eliminated due to the change in the drive instruction while the torque decrease control is being performed, the torque control unit sets a decrease rate of the torque corresponding to a decrease in the required driving force to be smaller than a decrease rate of the torque in the torque decrease control.

6. The control device for a vehicle according to claim 4, wherein
the torque control unit determines an increase rate of the torque such that the rotation angle of the motor changes to a forward direction of the vehicle in response to the torque return control being ended.

7. The control device for a vehicle according to claim 4, wherein
in response to the required driving force being eliminated due to the change in the drive instruction during execution of the torque return control, the torque control unit continues the torque return control until a decreased amount of the torque is increased.

8. The control device for a vehicle according to claim 4, wherein
the torque control further includes, after the torque return control is ended, a torque balance control for maintaining a stopped state of the vehicle in a state in which the torque is generated based on the drive instruction,
the torque control unit decreases the torque at a predetermined decrease rate in response to the required driving force being eliminated due to the change in the drive instruction while the torque balance control is being performed, and
the decrease rate is different from the decrease rate in the torque decrease control.

9. The control device for a vehicle according to claim 1, wherein
the torque control includes a torque decrease control for decreasing the torque to move the vehicle rearward and a torque return control for increasing the torque by an amount decreased by the torque decrease control, and
a change rate of the torque in the torque decrease control is smaller than a change rate of the torque in the torque return control.

10. The control device for a vehicle according to claim 1, further comprising
a notification control unit configured to issue a notification of the stall state, wherein
the notification control unit continuously issues the notification until the stall state is switched to a non-stall state due to a change in the drive instruction.
